(19) United States
(12) Patent Application Publication
(10) Pub. No.: US 2026/0301690 A1
(43) Pub. Date: Oct. 1, 2026

(54) GATE DRIVING CIRCUIT AND DISPLAY PANEL

(71) Applicant: HKC CORPORATION LIMITED, SHENZHEN (CN)

(72) Inventors: Xing LI, SHENZHEN (CN); Xiao ZHAO, SHENZHEN (CN); Lidan YE, SHENZHEN (CN)

(21) Appl. No.: 19/571,974

(22) Filed: Mar. 19, 2026

(30) Foreign Application Priority Data
Apr. 1, 2025 (CN) 202510404265.6

(51) Int. Cl. G09G 3/3266

(52) U.S. Cl. CPC G09G 3/3266; G09G 2300/0408; G09G 2320/064

(57) ABSTRACT

A gate driving circuit and a display panel are provided. The gate driving circuit may include multiple gate driving units connected in cascades. Each of the gate driving units includes a first output unit configured to output a first pulse signal, where the first pulse signal is a low potential pulse with a normal high potential; a second output unit configured to output a second pulse signal, where the second pulse signal is a pulse width modulation signal accompanied by a high potential pulse; a first control unit connected to a control terminal of the first output unit and configured to control the first output unit to output the first pulse signal; a second control unit connected to a control terminal of the second output unit and configured to control the second output unit to output the second pulse signal.

### CROSS REFERENCE TO RELATED APPLICATIONS

The present disclosure claims priority of Chinese Patent Application No. 202510404265.6, filed on Apr. 1, 2025, the entire contents of which are hereby incorporated by reference in their entireties.

### TECHNICAL FIELD

The present disclosure relates to the field of display panels, and in particular to a gate driving circuit and a display panel.

### BACKGROUND

With the development of display technology, an organic light emitting display (OLED) product is beginning to enter the public eye. Different from a liquid crystal display (LCD) product, the OLED may emit light by driving an organic light-emitting material with current. According to a saturation region current formula shown as below:

$${I}_{ds} = \frac{1}{2} μ \frac{W}{L} {{C}_{ox} ( Vgs - Vth )}^{2} ,$$

it can be seen that a threshold voltage Vth of a thin film transistor (TFT) may have a significant impact on the current.

A common OLED pixel driving circuit may include a reset process operated by a previous-stage scan signal Pscan(n−1), a sampling process operated by a current-row scan signal Pscan(n), and a light-emitting process controlled by a current-row switch signal EM(n). Different from the LCD, a switch signal may achieve periodic turning on and turning off of a circuit through periodic switching of an equivalent circuit of the light-emitting process, thereby implementing pulse width modulation (PWM) dimming.

### SUMMARY OF THE DISCLOSURE

According to a first aspect, some embodiments of the present disclosure provide a gate driving circuit. The gate driving circuit may include a plurality of gate driving units connected in cascades, where each of the gate driving units includes: a first output unit, configured to output a first pulse signal, where the first pulse signal may be a low potential pulse with a normal high potential; a second output unit, configured to output a second pulse signal, where the second pulse signal may be a pulse width modulation signal accompanied by a high potential pulse; a first control unit, connected to a control terminal of the first output unit and configured to control the first output unit to output the first pulse signal; and a second control unit, connected to a control terminal of the second output unit and configured to control the second output unit to output the second pulse signal.

According to a second aspect, some embodiments of the present disclosure provide a display panel. The display panel may include the gate driving circuit according to any one of the embodiments in the first aspect.

### BRIEF DESCRIPTION OF THE DRAWINGS

In order to more clearly describe the technical solutions in the embodiments of the present disclosure, the following will briefly introduce the drawings required in the description of the embodiments. Obviously, the drawings in the following description are only some embodiments of the present disclosure. For those skilled in the art, other drawings may be obtained based on these drawings without creative work.

FIG. 1 is a schematic structural diagram of a gate driving circuit according to some embodiments of the present disclosure.

FIG. 2 is a timing diagram of a first pulse signal and a second pulse signal according to some embodiments of the present disclosure.

FIG. 3 is a schematic structural diagram of the gate driving unit according to some embodiments of the present disclosure.

FIG. 4 is a schematic structural diagram of the gate driving unit according to some embodiments of the present disclosure.

FIG. 5 is a partial schematic structural diagram of the gate driving unit according to some embodiments of the present disclosure.

FIG. 6 is a partial schematic structural diagram of the gate driving unit according to some embodiments of the present disclosure.

FIG. 7 is a partial schematic structural diagram of the gate driving unit according to some embodiments of the present disclosure.

FIG. 8 is a partial schematic structural diagram of the gate driving unit according to some embodiments of the present disclosure.

FIG. 9 is a partial schematic structural diagram of the gate driving unit according to some embodiments of the present disclosure.

FIG. 10 is a partial schematic structural diagram of the gate driving unit according to some embodiments of the present disclosure.

FIG. 11 is a partial schematic structural diagram of the gate driving unit according to some embodiments of the present disclosure.

FIG. 12 is a partial schematic structural diagram of the gate driving unit according to some embodiments of the present disclosure.

FIG. 13 is a schematic circuit structure diagram of the gate driving unit according to some embodiments of the present disclosure.

FIG. 14 is a driving timing diagram of the gate driving unit according to some embodiments of the present disclosure.

FIG. 15 is a circuit diagram of a first driving stage of the gate driving unit according to some embodiments of the present disclosure.

FIG. 16 is a circuit diagram of a second driving stage of the gate driving unit according to some embodiments of the present disclosure.

FIG. 17 is a circuit diagram of a third driving stage of the gate driving unit according to some embodiments of the present disclosure.

FIG. 18 is a circuit diagram of a fourth driving stage of the gate driving unit according to some embodiments of the present disclosure.

FIG. 19 is a schematic structural diagram of a display panel according to some embodiments of the present disclosure.

FIG. 20 is a schematic structural diagram of a pixel driving circuit according to some embodiments of the present disclosure.

### DETAILED DESCRIPTION

The following will be a clear and complete description of the technical solutions in the embodiments of the present disclosure in conjunction with the accompanying drawings in the embodiments of the present disclosure. Obviously, the described embodiments are only a part of the embodiments of the present disclosure, and not all of them. Based on the embodiments in the present disclosure, all other embodiments obtained by those skilled in the art without making creative labor fall within the scope of the present disclosure.

The terms used in the embodiments of the present disclosure are used solely for the purpose of describing particular embodiments and are not intended to limit the present disclosure. The singular forms of “a”, “said”, and “the” as used in the embodiments of the present disclosure and the appended claims are also intended to include plural form, unless clearly indicated. Terms “a plurality” generally include at least two, but does not exclude the inclusion of at least one.

It should be understood that the term “and/or” as used herein is simply a description of the association of related objects, indicating that three relationships can exist, e.g., A and/or B, which can mean: A alone, both A and B, and B alone. In addition, the character “/” in this document generally indicates that the before and after associated objects are in an “or” relationship. The terms “first”, “second”, and the like in the description, claims, and aforesaid drawings of the present disclosure are used to distinguish similar objects, rather than describing a particular sequence or order.

It is to be understood that the term “include”, “comprise”, or any other variant used herein is intended to cover non-exclusive inclusion, such that a process, method, article, or apparatus comprising a set of elements may include not only those elements, but also other elements not explicitly listed, or other elements that are not explicitly listed, or that are inherent to such process, method, article, or apparatus. Without further limitation, elements defined by the statement “including” do not preclude the existence of additional identical elements in the process, method, article, or apparatus that include the elements.

To be noted that, all directional indications (such as up, down, left, right, forward, backward . . . ) in the present disclosure are configured to explain relative positions between components at a particular pose (the pose shown in the accompanying drawings), movements, and so on. When the particular pose changes, the directional indications may change accordingly.

“Embodiment” herein means that a particular feature, structure, or characteristic described with reference to embodiments may be included in at least one embodiment of the present disclosure. The term appearing in various places in the specification are not necessarily as shown in the same embodiment, and are not exclusive or alternative embodiments that are mutually exclusive with other embodiments. Those skilled in the art will understand explicitly and implicitly that the embodiments described herein may be combined with other embodiments.

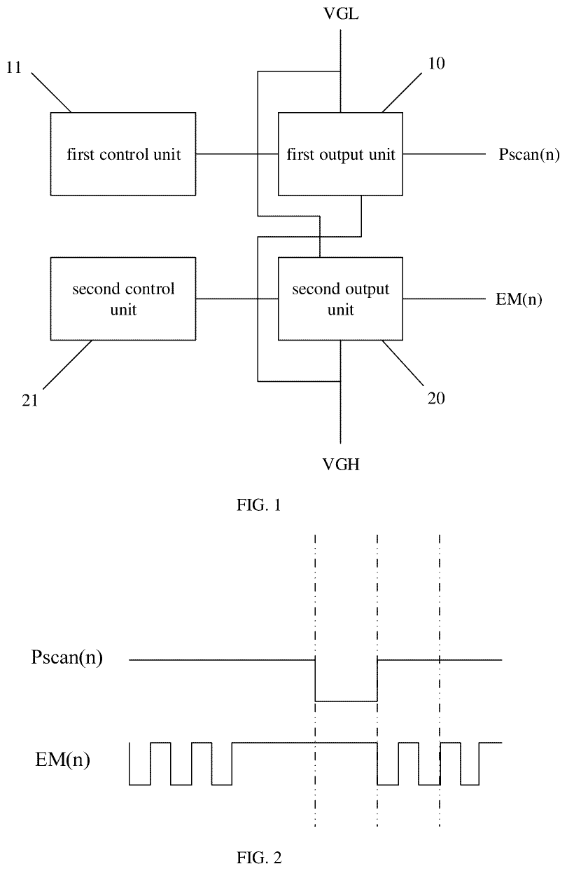

A gate driving circuit may be provided by some embodiments of the present disclosure. The gate driving circuit may include a plurality of gate driving units connected in cascades. In some embodiments, as shown in FIG. 1, FIG. 1 is a schematic structural diagram of a gate driving circuit according to some embodiments of the present disclosure. As shown in FIG. 1, each of the gate driving units GOA may at least include a first output unit 10, a second output unit 20, a first control unit 11, and a second control unit 21.

The first output unit 10 may be configured to output a first pulse signal Pscan(n). The first pulse signal Pscan(n) may be a low potential pulse with a normal high potential. That is, the low potential pulse may be effective in a low-potential/low-level state, and the normal high potential may be effective in a high-potential/high-level state. The first pulse signal Pscan(n) may be a low potential scan signal, and may be configured to control writing of a data signal in the display panel.

The second output unit 20 may be configured to output a second pulse signal EM(n). The second pulse signal EM(n) may be a pulse width modulation signal accompanied by a high potential pulse. In some embodiments, the second pulse signal EM(n) may be a switch signal, and may be configured to modulate a light-emitting frequency of a light-emitting unit.

In some embodiments, each of the first output unit 10 and the second output unit 20 may be connected to a high potential signal line VGH and a low potential signal line VGL. The first output unit 10 and the second output unit 20 may be configured to output the first pulse signal Pscan(n) and the second pulse signal EM(n).

The first control unit 11 may be connected to a control terminal of the first output unit 10. The first control unit 11 may be configured to control the first output unit 10 to output the first pulse signal Pscan(n).

The second control unit 21 may be connected to a control terminal of the second output unit 20. The second control unit 21 may be configured to control the second output unit 20 to output the second pulse signal EM(n).

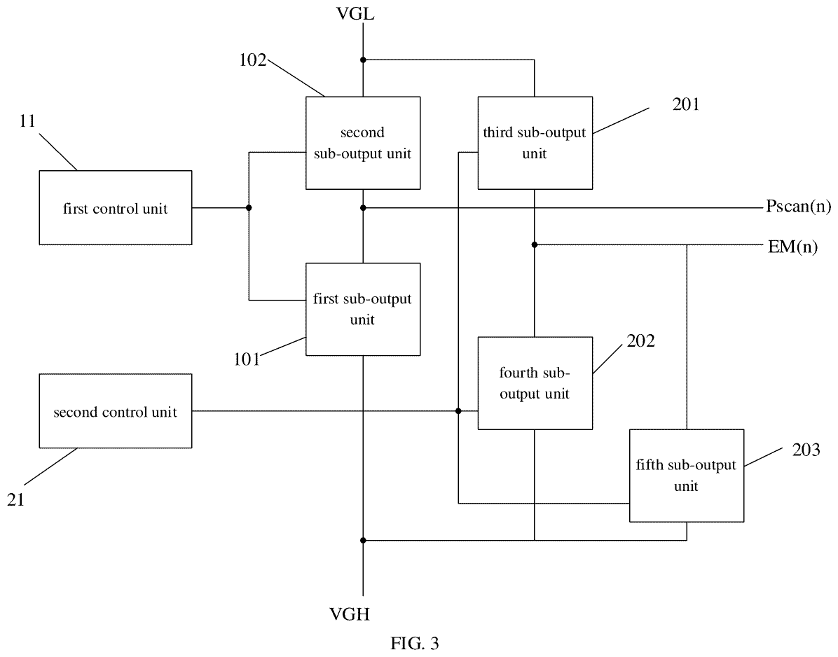

In some embodiments, as shown in FIG. 2, FIG. 2 is a timing diagram of a first pulse signal and a second pulse signal according to some embodiments of the present disclosure. As shown in FIG. 2, each of the first pulse signal Pscan(n) and the second pulse signal EM(n) may include a high potential pulse (i.e., a high-level voltage) and a low potential pulse (i.e., a low-level voltage). A duty cycle of the high potential pulse and the low potential pulse in the first pulse signal Pscan(n) may be different from a duty cycle of the high potential pulse and the low potential pulse in the second pulse signal EM(n). A timing sequence of the high potential pulse and the low potential pulse in the first pulse signal Pscan(n) may be different from a timing sequence of the high potential pulse and the low potential pulse in the second pulse signal EM(n). In some embodiments, the second pulse signal EM(n) may be delayed by a timing sequence or a phase from the first pulse signal Pscan(n). In some embodiments, a pulse frequency of the second pulse signal EM(n) may be greater than that of the first pulse signal Pscan(n). In some embodiments, the pulse frequency of the second pulse signal EM(n) may be an integer multiple of that of the first pulse signal Pscan(n). As shown in the embodiment, within a timing sequence, the pulse frequency of the second pulse signal EM(n) may be three times that of the first pulse signal Pscan(n). That is, the timing sequence occupied by three second pulse signals EM(n) may be the same as the timing sequence occupied by one first pulse signal Pscan(n), which may be compared within the same phase width.

In some embodiments, as shown in FIG. 3, FIG. 3 is a schematic structural diagram of the gate driving unit according to some embodiments of the present disclosure. As shown in FIG. 3, the first output unit 10 may include a first sub-output unit 101 and a second sub-output unit 102. The first sub-output unit 101 may be connected to the high potential signal line VGH. The first sub-output unit 101 may be configured to output a high potential pulse (i.e., a high potential level) of the first pulse signal Pscan(n) according to a control signal output by the first control unit 11. The second sub-output unit 102 may be connected to the low potential signal line VGL. The second sub-output unit 102 may be configured to output a low potential pulse (i.e., low potential level) of the first pulse signal Pscan(n) according to the control signal output by the first control unit 11. The first pulse signal Pscan(n) may be a pulse signal formed by high potentials and low potentials alternately turned on.

In some embodiments, an output terminal of the first control unit 11 may be connected to a control terminal of the first sub-output unit 101 and a control terminal of the second sub-output unit 201 at the same time. The first sub-output unit 101 and the second sub-output unit 102 may include two transistors with opposite driving characteristics. That is, when the first sub-output unit 101 is turned on, the second sub-output unit 102 may be turned off. Alternatively, when the second sub-output unit 102 is turned on, the first sub-output unit 101 may be turned off. Therefore, the first control unit 11 may be configured to control the first sub-output unit 101 and the second sub-output unit 102 to be alternately turned on, such that the first pulse signal Pscan(n) may be output.

In some embodiments, the second output unit 20 may include a third sub-output unit 201, a fourth sub-output unit 202, and a fifth sub-output unit 203.

The third sub-output unit 201 may be connected to the low potential signal line VGL. The third sub-output unit 201 may be configured to output a low potential pulse of the pulse width modulation signal. The fourth sub-output unit 202 may be connected to the high potential signal line VGH. The fourth sub-output unit 202 may be configured to output a high potential pulse of the pulse width modulation signal. The fifth sub-output unit 203 may be connected to the high potential signal line VGH. The fifth sub-output unit 203 may be configured to output a high potential pulse according to a control signal output by the second control unit.

It should be noted that the second pulse signal EM(n) may include a normal high potential pulse, and a high potential pulse and a low potential pulse of the pulse width modulation signal. In some embodiments, the high potential pulse and the low potential pulse of the pulse width modulation signal may be referred to a high potential pulse and a low potential pulse in the pulse width modulation stage (i.e., in a light-emitting stage). That is, in the light-emitting stage, the high potential pulse of the pulse width modulation signal may be effective in the high-potential/high-level state, and the high potential pulse and the low potential pulse of the pulse width modulation signal may be effective in the low-potential/low-level state. The normal high potential pulse may be referred to a high potential pulse in a non-light-emitting stage. That is, in the non-light-emitting stage, the normal high potential pulse may be effective in the high-potential/high-level state.

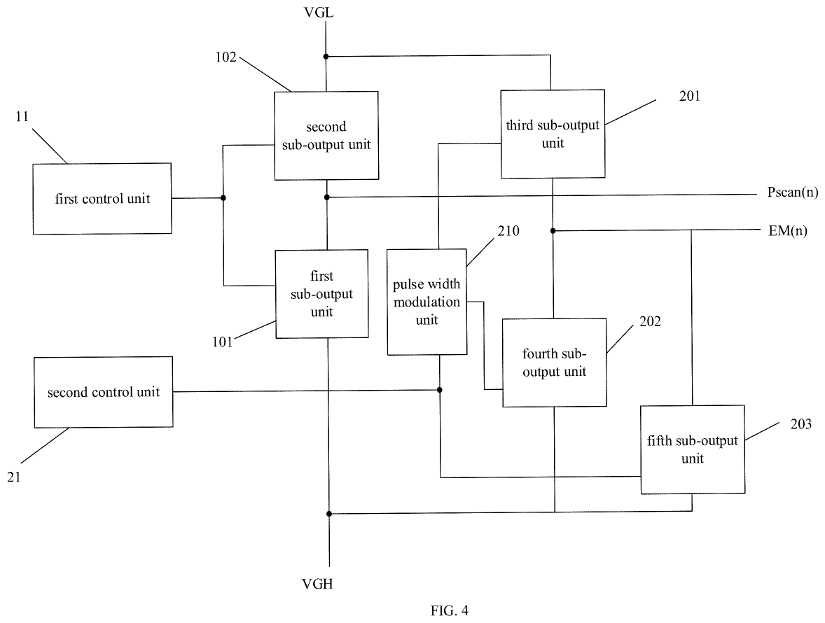

In some embodiments, as shown in FIG. 4, FIG. 4 is a schematic structural diagram of the gate driving unit according to some embodiments of the present disclosure. As shown in FIG. 4, the third sub-output unit 201 and the fourth sub-output unit 202 may further include a pulse width modulation unit 210. The pulse width modulation unit 210 may be configured to output a pulse width modulation control signal, such that the third sub-output unit 201 and the fourth sub-output unit 202 may be alternately turned on in the light-emitting stage to generate a pulse width modulation signal. The pulse width modulation signal may include at least one group of alternating high potential pulses and low potential pulses. In some embodiments, the pulse width modulation unit 210 may include a first pulse width modulation unit 220 and a second pulse width modulation unit 230, which may be referred to descriptions in the subsequent embodiments. In some embodiments, the pulse width modulation unit 210 may also include a modulation unit, and may be configured to output alternating high pulse modulation signals and low pulse modulation signals, such that it may be possible to control the third sub-output unit 201 and the fourth sub-output unit 202 to be alternately turned on. At this time, the third sub-output unit 201 and the fourth sub-output unit 202 may include two transistors with opposite driving characteristics (i.e., a N-type transistor and a P-type transistor).

In some embodiments, a driving characteristic of the pulse width modulation unit 210 in the third sub-output unit 201 and the fourth sub-output unit 202 may be opposite to that of the fifth sub-output unit 203. That is, when the third sub-output unit 201 and the fourth sub-output unit 202 work, the fifth sub-output unit 203 may not work or may be in a non-working state, such that it may be possible to output the pulse width modulation signal (i.e., the light-emitting stage). When the third sub-output unit 201 and the fourth sub-output unit 202 do not work or in the non-working state, the fifth sub-output unit 203 may work or may be in a working state, such that it may be possible output the normal high potential pulse (i.e., the non-light-emitting stage).

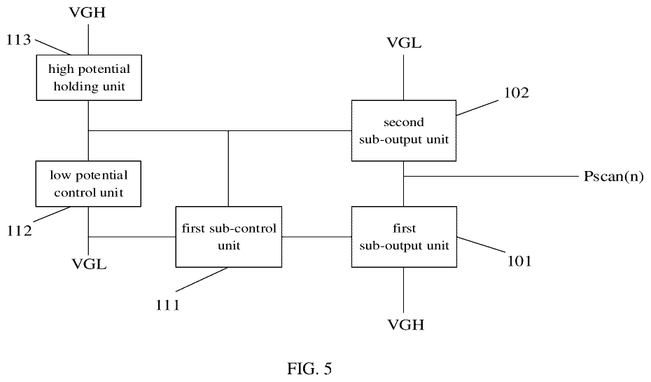

In some embodiments, the first control unit 11 may include a first sub-control unit 111, a high potential holding unit 113, and a low potential control unit 112. As shown in FIG. 5, FIG. 5 is a partial schematic structural diagram of the gate driving unit according to some embodiments of the present disclosure. The first sub-control unit 111 may be connected to the control terminal of the first sub-output unit 101. The first sub-control unit 111 may be configured to output a turn-on signal or an ON signal to the control terminal of the first sub-output unit 101, such that it may be possible to control the first sub-output unit 101 to output the high potential pulse.

In some embodiments, the first sub-control unit 111 may further include the low potential signal line VGL. The turn-on signal may be a low potential signal. The first sub-control unit 111 may be configured to transmit the low potential signal to the control terminal of the first sub-output unit 101, such that it may be possible to control the first sub-output unit 101 to be turned on.

The low potential control unit 112 may be connected to a control terminal of the first sub-control unit 111 and a control terminal of the second sub-output unit 102. The low potential control unit 112 may be configured to transmit a low potential control signal to the control terminal of the first sub-control unit 111 and the control terminal of the second sub-output unit 102, such that it may be possible to control outputting of the second sub-output unit 102, and outputting the first sub-output unit 101 may be controlled through the first sub-control unit 111.

The high potential holding unit 113 may be connected to the control terminal of the first sub-control unit 111 and the control terminal of the second sub-output unit 102. The high potential holding unit 113 may be configured to hold/maintain the control terminal of the first sub-control unit 111 and the control terminal of the second sub-output unit 102 in a high-level state, such that it may be possible to control the outputting of the first sub-output unit 101 and the outputting of the second sub-output unit 102.

The first sub-control unit 111 and the second sub-output unit 102 may include a group of transistors with opposite driving characteristics. That is, when the first sub-control unit 111 is turned on, the second sub-output unit 102 may be turned off. Alternatively, when the second sub-output unit 102 is turned on, the first sub-control unit 111 may be turned off. When the first sub-control unit 111 is turned on, the first sub-output unit 101 may also be controlled to be turned on. The first sub-output unit 101 and the second sub-output unit 102 may include transistors with the same driving characteristics. In some embodiments, each of the first sub-output unit 101 and the second sub-output unit 102 may be a P-type transistor turned on in a low-level state. It can be understood that each of the first sub-output unit 101 and the second sub-output unit 102 may also be a N-type transistor turned on in a high-level state, and the turn-on signal of each of the first sub-output unit 101 and the second sub-output unit 102 or the control signal each of the first sub-output unit 101 and the second sub-output unit 102 may also be a high potential signal.

In the embodiments, the high potential holding unit 113 may hold the control terminal of the first sub-control unit 111 and the control terminal of the second sub-output unit 102 in the high-level state, such that the first sub-output unit 101 may be remained/maintained normally on, and the second sub-output unit 102 may be remained normally off. The low potential control unit 112 may transmit the control signal (i.e., the low potential control signal) to the control terminal of the first sub-control unit 111 and the control terminal of the second sub-output unit 102, such that the first sub-output unit 101 may be turned off and the second sub-output unit 102 may be turned on, thereby outputting a low potential pulse of the first pulse signal Pscan(n).

In some embodiments, the low potential control unit 112 may include the low potential signal line VGL and a switching transistor. The high potential holding unit 113 may include the high potential signal line VGH and a first resistor R1. The first resistor R1 may be a large resistor. A speed at which the low potential control unit 112 transmits the low potential signal to the control terminal of the first sub-control unit 111 and the control terminal of the second sub-output unit 102 may be greater than a speed at which the high potential holding unit 113 transmits the high potential signal, such that controlling of the first sub-control unit 111 and the second sub-output unit 102 by the low potential control unit 112 may be superior to or greater than controlling force of the high potential holding unit 113. In other embodiments, the high potential holding unit 113 may also include the high potential signal line VGH and the switching transistor, which is not limited herein.

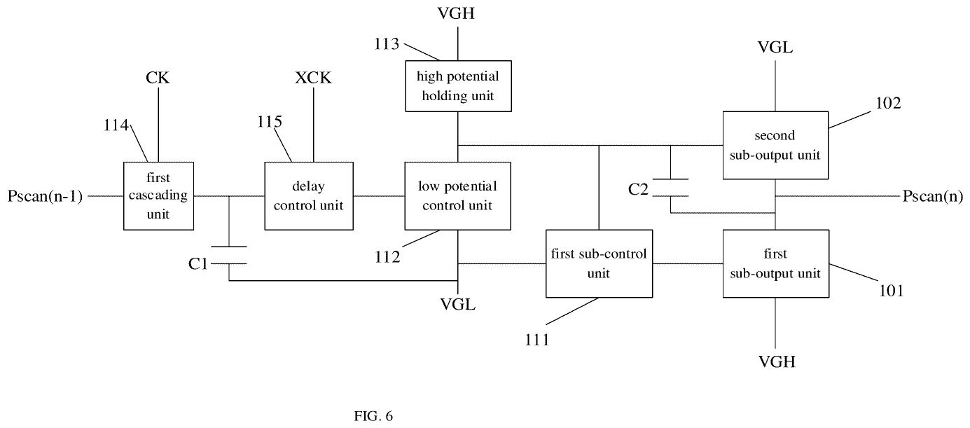

A control terminal of the low potential control unit 112 may be further connected to a cascading unit. In some embodiments, as shown in FIG. 6, FIG. 6 is a partial schematic structural diagram of the gate driving unit according to some embodiments of the present disclosure. As shown in FIG. 6, the first control unit 11 may further include a first cascading unit 114 connected to a previous-stage first output unit 10. The first cascading unit 114 may be configured to receive a first pulse signal Pscan(n−1) transmitted by the previous-stage first output unit 10. In some embodiments, an input terminal of the first cascading unit 114 may be connected to an output terminal of the previous-stage first output unit 10.

A first memory unit C1 may be connected to the first cascading unit 114. The first memory unit C1 may be configured to store a potential signal of a previous-stage first pulse signal Pscan(n). The potential signal may include a high potential pulse signal and a low potential pulse signal.

A delay control unit 115 may be disposed between the first memory unit C1 and the control terminal of the low potential control unit 112. The delay control unit 115 may be configured to control a connection between the first memory unit C1 and the control terminal of the low potential control unit 112. The delay control unit 115 may be further configured to control the potential signal stored in the first memory unit C1 to be transmitted to the control terminal of the low potential control unit 112, such that it may be possible to control the low potential control unit 112 to be turned on or turned off.

In some embodiments, a first plate of the first memory unit C1 may be connected to an output terminal of the first cascading unit 114 and an input terminal of the delay control unit 115, such that it may be possible to store the first pulse signal Pscan(n−1) transmitted by the first cascading unit 114 at a previous timing, and transmit the stored first pulse signal Pscan(n−1) to the control terminal of the low potential control unit 112 through the delay control unit 115 at a subsequent timing. In some embodiments, a second plate of the first memory unit C1 may be connected to the low potential signal line VGL. In other embodiments, the second plate of the first memory unit C1 may be further connected to the high potential signal line VGH, or connected to a ground line, or connected to a common potential line, which is not limited herein.

In some embodiments, the control terminal of the first cascading unit 114 and the control terminal of the delay control unit 115 may be connected to a group of control signal lines with opposite phases. In some embodiments, group of control signal lines with opposite phases may include a first control signal line XCK and a second control signal line CK. A phase of a control signal transmitted by the first control signal line XCK may be opposite to a phase of a control signal transmitted by the second control signal line CK, such that when the first cascading unit 114 is controlled to be turned on, the delay control unit 115 may be turned off. Alternatively, when the first cascading unit 114 is controlled to be turned off, the delay control unit 115 may be turned on. In some embodiments, the first cascading unit 114 and the delay control unit 115 may include transistors with the same driving characteristics. In other embodiments, the control terminal of the first cascading unit 114 and the control terminal of the delay control unit 115 may also be connected to the same control signal line. The control signal may include a high/low level signal, and the first cascading unit 114 and the delay control unit 115 may include a group of transistors with opposite driving characteristics.

In some embodiments, in a first stage, the previous-stage first pulse signal Pscan(n−1) may be configured to transmit a low potential pulse of the first pulse signal Pscan(n−1) to the first memory unit C1 through the first cascading unit 114. In the first stage, the high potential holding unit 113 may be configured to transmit a high potential signal to the control terminal of the first sub-control unit 111 and the control terminal of the second sub-output unit 102, such that it may be possible to control the first sub-control unit 111 to be turned on, thereby enabling the first sub-control unit 111 to control the first sub-output unit 101 to output a high potential pulse of the first pulse signal Pscan(n).

In a second stage, the first memory unit C1 may be configured to transmit a stored low potential pulse to the control terminal of the low potential control unit 112 through the delay control unit 115, such that it may be possible to control a transistor of the low potential control unit 112 to be turned on, thereby transmitting a low potential control signal to the control terminal of the first sub-control unit 111 and the control terminal of the second sub-output unit 102. In this way, it may be enable a transistor of the first sub-control unit 111 to be turned off and enable the second sub-output unit 102 to be turned on, thereby outputting the low potential pulse of the first pulse signal Pscan(n).

In some embodiments, the first output unit 10 may further include a second memory unit C2. The second memory unit C2 may be connected to the control terminal of the second sub-output unit 102. The second memory unit C2 may be configured to accelerate the turn-off of the second sub-output unit 102. The second memory unit C2 may be a Miller capacitor, which may be used as a buffer for a Miller effect to accelerate the rapid turn-off of the second sub-output unit 102 after the second stage, such that it may be possible to ensure/allow the light-emitting stage to operate normally after the second stage.

A first plate of the second memory unit C2 may be connected to the control terminal of the second sub-output unit 102. A second plate of the second memory unit C2 may be connected to an output terminal of the second sub-output unit 102. In the second stage, each of the first plate and the second plate of the second memory unit C2 may store a low potential. In the light-emitting stage after the second stage, the second plate of the second memory unit C2 may be in the high-level state, such that according to a capacitive coupling effect, the first plate of the second memory unit C2 may be coupled to a high potential, thereby accelerating the turn-off of the second sub-output unit 102.

In some embodiments, the first sub-control unit 111 may include the low potential signal line VGL and a first transistor T1 turned on in the high-level state. An input terminal of the first transistor T1 may be connected to the low potential signal line VGL. An output terminal of the first transistor T1 may be connected to the control terminal of the first sub-output unit 101. The first transistor T1 may be configured to transmit a low potential turn-on signal to the control terminal of the first sub-output unit 101. The first transistor T1 may be the N-type transistor.

In some embodiments, the first sub-control unit 111 may include the low potential signal line VGL, a first transistor T1 turned on in the high-level state, and a second transistor T2 turned on in the low-level state. The second transistor T2 may be disposed between control terminals of the first transistor T1. A control terminal of the second transistor T2 may be connected to an output unit of the first transistor T1 and may be turned on in response to receiving the low potential signal. An input terminal of the second transistor T2 may be connected to the low potential signal line VGL. An output terminal of the second transistor T2 may be connected to the control terminal of the first sub-output unit 101. The second transistor T2 may be configured to control the low potential signal line VGL to output the turn-on signal to the control terminal of the first sub-output unit 101 according to the control signal output by the first transistor T1. The first transistor T1 may be the N-type transistor, and the second transistor T2 may be the P-type transistor.

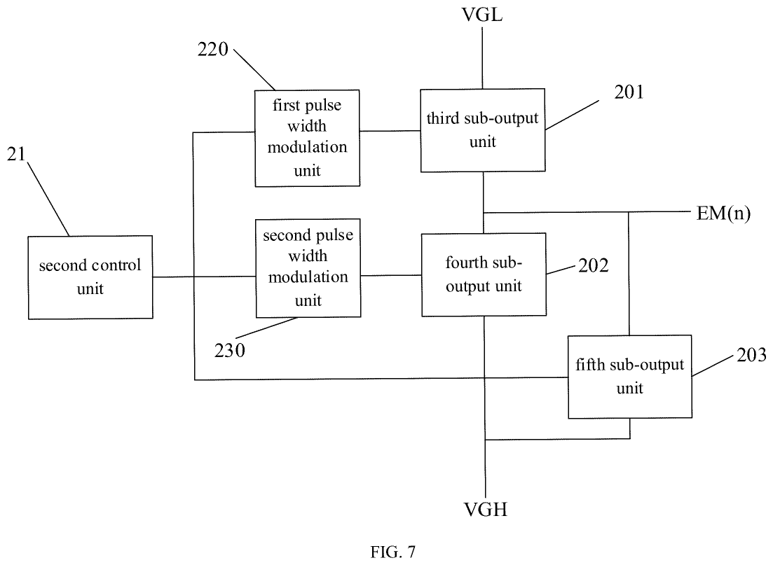

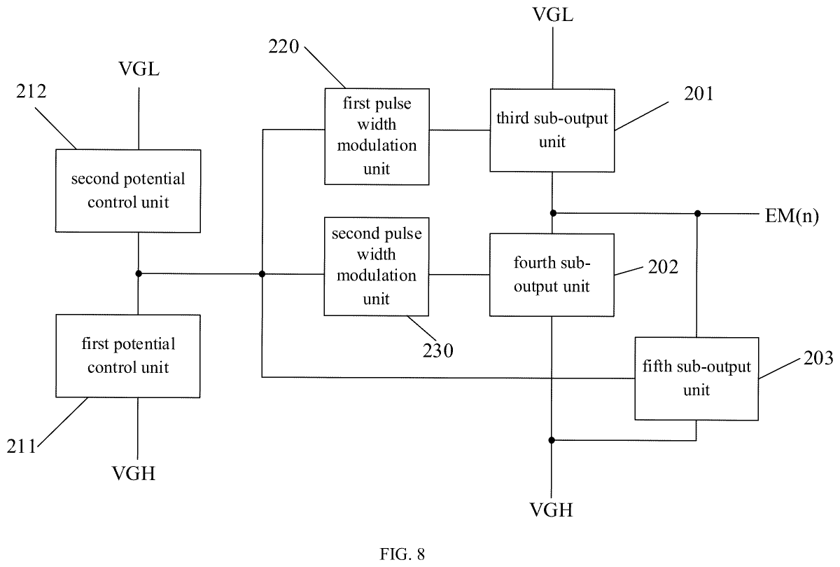

In some embodiments, as shown in FIG. 7, FIG. 7 is a partial schematic structural diagram of the gate driving unit according to some embodiments of the present disclosure.

In some embodiments, the pulse width modulation unit 210 may include a first pulse width modulation unit 220 and a second pulse width modulation unit 230. The first pulse width modulation unit 220 may be connected to the control terminal of the third sub-output unit 201. The first pulse width modulation unit 220 may be configured to output a first pulse width modulation signal PWM-CK to the control terminal of the third sub-output unit 201. The second pulse width modulation unit 230 may be connected to the control terminal of the fourth sub-output unit 202. The second pulse width modulation unit 230 may be configured to output a second pulse width modulation signal PWM-XCK to the control terminal of the fourth sub-output unit 202. The first pulse width modulation signal PWM-CK and the second pulse width modulation signal PWM-XCK may be a group of level signals with opposite pulse phases and the same frequency. That is, when the first pulse width modulation signal PWM-CK controls the third sub-output unit 201 to be turned on, the second pulse width modulation signal PWM-XCK may be configured to control the fourth sub-output unit 202 to be turned off. Alternatively, when the first pulse width modulation signal PWM-CK controls the third sub-output unit 201 to be turned off, the second pulse width modulation signal PWM-XCK may be configured to control the fourth sub-output unit 202 to be turned on. A frequency of each of the first pulse width modulation signal PWM-CK and the second pulse width modulation signal PWM-XCK may be greater than a frequency of the first pulse signal Pscan(n). In some embodiments, a pulse frequency of each of the first pulse width modulation signal PWM-CK and the second pulse width modulation signal PWM-XCK may be an integer multiple of a pulse frequency of the first pulse signal Pscan(n). In some embodiments, the integer multiple may be greater than 1, which may be 2 times, 3 times, 4 times, etc. In this way, in the light-emitting stage, the first pulse width modulation signal PWM-CK and the second pulse width modulation signal PWM-XCK may include at least one group of a low-level signal and a high-level signal, such that the second pulse signal EM(n) may output the turn-on signal and a turn-off signal in the light-emitting stage. In some embodiments, the third sub-output unit 201 and the fourth sub-output unit 202 may include transistors with the same driving characteristics, which may be the P-type transistor.

Alternating high potential signals and low potential signals may be output through the second control unit 21, such that it may be possible to control the first pulse width modulation unit 220, the second pulse width modulation unit 230 and the fifth sub-output unit 203 to be turned on, respectively.

In some embodiments, as shown in FIG. 8, FIG. 8 is a partial schematic structural diagram of the gate driving unit according to some embodiments of the present disclosure. As shown in FIG. 8, the second control unit 21 may at least include a first potential control unit 211 and a second potential control unit 212.

An input terminal of the first potential control unit 211 may be connected to the high potential signal line VGH. An output terminal of the first potential control unit 211 may be connected to the control terminal of the first pulse width modulation unit 220, the control terminal of the second pulse width modulation unit 230, and the control terminal of the fifth sub-output unit 203. The first potential control unit 211 may be configured to transmit a high potential control signal to the control terminal of the first pulse width modulation unit 220, the control terminal of the second pulse width modulation unit 230, and the control terminal of the fifth sub-output unit 203, such that it may be possible to control the first pulse width modulation unit 220 and the second pulse width modulation unit 230 to be turned on, and control the fifth sub-output unit 203 to be turned off.

An input terminal of the second potential control unit 212 may be connected to the low potential signal line VGL. An output terminal of the second potential control unit 212 may be connected to the control terminal of the first pulse width modulation unit 220, the control terminal of the second pulse width modulation unit 230, and the control terminal of the fifth sub-output unit 203. The second potential control unit 212 may be configured to transmit a low potential control signal to the control terminal of the first pulse width modulation unit 220, the control terminal of the second pulse width modulation unit 230, and the control terminal of the fifth sub-output unit 203, such that it may be possible to control the first pulse width modulation unit 220 and the second pulse width modulation unit 230 to be turned off, and control the fifth sub-output unit 203 to be turned on. It should be noted that the turn-on and turn-off here may also be referred to a working/operating state and a non-working state. That is, it may be possible to enable the first pulse width modulation unit 220 and the second pulse width modulation unit 230 to work, and enable the fifth sub-output unit 203 to do not work or to be in the non-working state. Alternatively, it may be possible to enable the fifth sub-output unit 203 to work, and enable the first pulse width modulation unit 220 and the second pulse width modulation unit 230 to do not work.

In some embodiments, each of the first pulse width modulation unit 220 and the second pulse width modulation unit 230 may include a N-type transistor turned on in the high-level state. The fifth sub-output unit 203 may include a P-type transistor turned on in the low-level state. In other embodiments, each of the first pulse width modulation unit 220 and the second pulse width modulation unit 230 may also include the P-type transistor. The fifth sub-output unit 203 may include the N-type transistor. The first potential control unit 211 may be configured to transmit the low potential control signal. The second potential control unit 212 may be configured to transmit the high potential control signal.

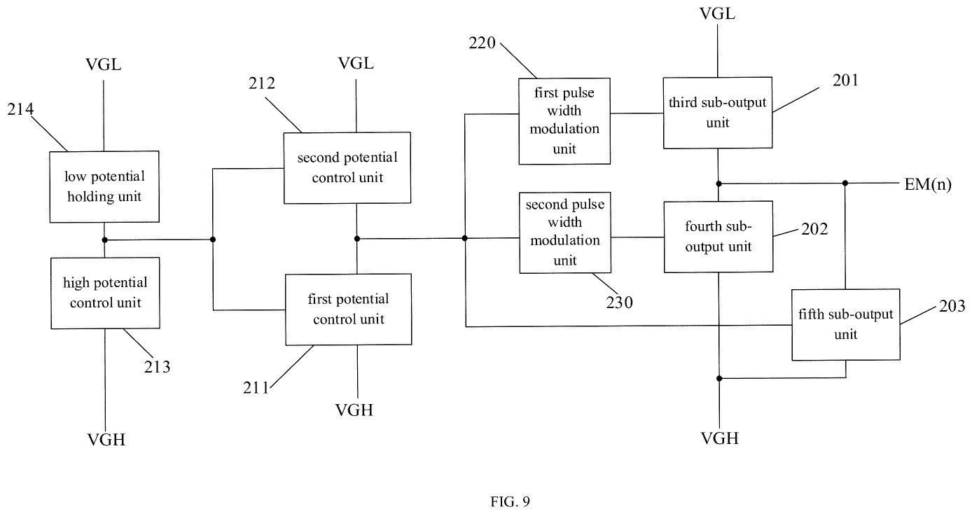

In some embodiments, as shown in FIG. 9, FIG. 9 is a partial schematic structural diagram of the gate driving unit according to some embodiments of the present disclosure. As shown in FIG. 9, the second control unit 21 may further include a high potential control unit 213 and a low potential holding unit 214. Each of an output terminal of the high potential control unit 213 and an output terminal of the low potential holding unit 214 may be connected to the control terminal of the first potential control unit 211 and the control terminal of the second potential control unit 212, such that it may be configured to control the first potential control unit 211 to be turned on or control the second potential control unit 212 to be turned on.

In some embodiments, the first potential control unit 211 and the second potential control unit 212 may include a group of transistors with opposite driving characteristics. It should be understood that in other embodiments, the control terminal of the first potential control unit 211 and the control terminal of the second potential control unit 212 may also be controlled by a pulse signal line, which may be a low potential pulse with a normal high potential or a high potential pulse with a normal low potential. The pulse signal line may be a cascaded first pulse signal line.

The high potential control unit 213 may be configured to transmit the high potential signal to the control terminal of the first potential control unit 211 and the control terminal of the second potential control unit 212, such that it may be possible to control the first potential control unit 211 to be turned on and control the second potential control unit 212 to be turned off. The low potential holding unit 214 may be configured to transmit the low potential signal to the control terminal of the first potential control unit 211 and the control terminal of the second potential control unit 212, such that it may be possible to control the first potential control unit 211 to be turned off and control the second potential control unit 212 to be turned on.

When the high potential control unit 213 is in the non-working state, the low potential holding unit 214 may hold/remain the control terminal of the first potential control unit 211 and the control terminal of the second potential control unit 212 in the low-level state, such that it may be possible to enable the fifth sub-output unit 203 to output the normal high potential pulse.

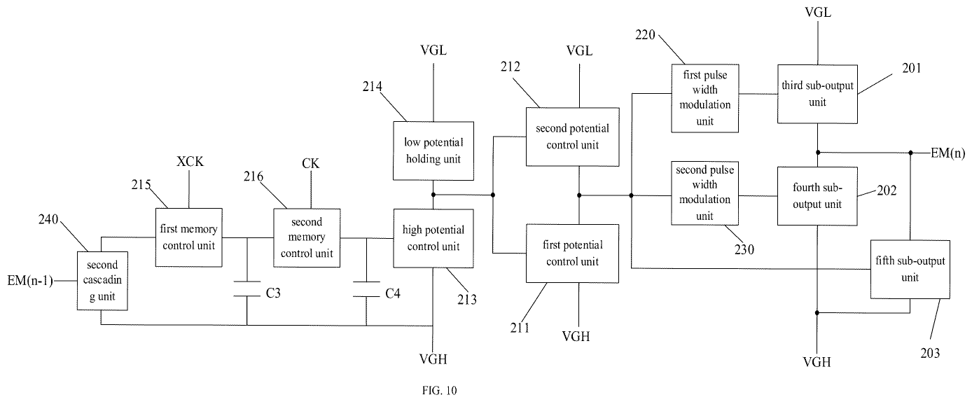

In some embodiments, as shown in FIG. 10, FIG. 10 is a partial schematic structural diagram of the gate driving unit according to some embodiments of the present disclosure. As shown in FIG. 10, the gate driving unit, such as the second control unit 21, may further include a second cascading unit 240, a first memory control unit 215, a third memory unit C3, a second memory control unit 216, and a fourth memory unit C4.

In some embodiments, the second cascading unit 240 may be connected to an output terminal of the previous-stage second output unit 20. The second cascading unit 240 may be configured to receive a second pulse signal EM(n−1) output by the previous-stage second output unit 20. The second cascading unit 240 may be further configured to control the transmission of a control signal to a control terminal of the high potential control unit 213 according to the second pulse signal EM(n−1) output by the previous-stage second output unit 20. The control signal may be the high-level voltage.

The first memory control unit 215 may be connected to the second cascading unit 240. The first memory control unit 215 may be configured to control the transmission of the control signal to the control terminal of the high potential control unit 213 according to an on/off status of the second cascading unit 240. In some embodiments, an input terminal of the first memory control unit 215 may be connected to the high potential signal line VGH. An output terminal of the first memory control unit 215 may be connected to the third memory unit C3. In some embodiments, the input terminal of the first memory control unit 215 may be connected to the high potential signal line VGH through the second cascading unit 240. In other embodiments, the second cascading unit 240 may be connected to a control terminal of the first memory control unit 215. The second cascading unit 240 may be configured to control the first memory control unit 215 to transmit the control signal to the high potential control unit 213.

The third memory unit C3 may be connected to the output terminal of the first memory control unit 215. The third memory unit C3 may be configured to store a control signal transmitted by the first memory control unit 215.

The second memory control unit 216 may be connected to the third memory unit C3. The second memory control unit 216 may be configured to control the third memory unit C3 to transmit the control signal to the control terminal of the high potential control unit 213.

The gate driving unit may further include a fourth memory unit C4. The fourth memory unit C4 may be connected to an output terminal of the second memory control unit 216. The fourth memory unit C4 may be configured to store a control signal transmitted by the second memory control unit 216 until an arrival of a cut-off signal (i.e., the low-level voltage) at a next timing, such that it may be possible to ensure that the high potential control unit 213 may be always in a turned-on state before the arrival of the cut-off signal at the next timing.

In some embodiments, the control terminal of the first memory control unit 215 may be connected to one of two control signal lines (CK and XCK) with opposite pulse phases. The control terminal of the second memory control unit 216 may be connected to the other one of the two control signal lines (CK and XCK) with opposite pulse phases.

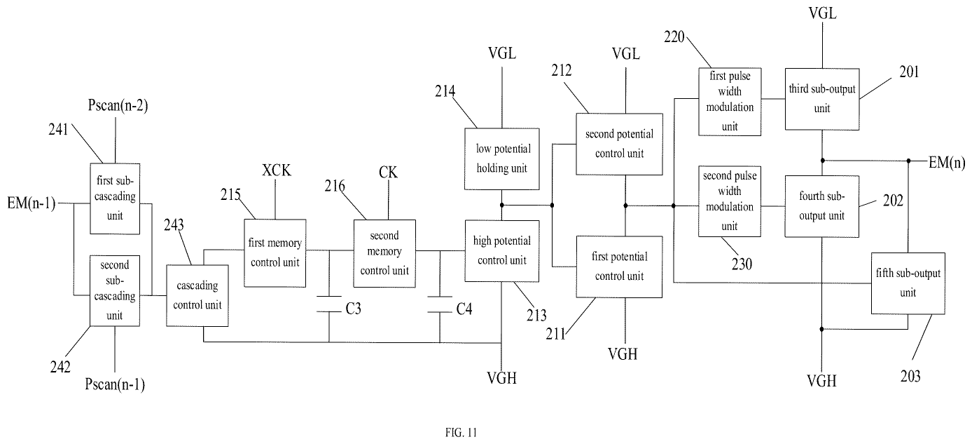

In some embodiments, as shown in FIG. 11, FIG. 11 is a partial schematic structural diagram of the gate driving unit according to some embodiments of the present disclosure. As shown in FIG. 11, the second cascading unit 240 may include a first sub-cascading unit 241, a second sub-cascading unit 242, and a cascading control unit 243.

A control terminal of the first sub-cascading unit 241 may be connected to an output terminal of two-previous-stage first output unit 10. An input terminal of the first sub-cascading unit 241 may be connected to the output terminal of the previous-stage second output unit 20. The first sub-cascading unit 241 may be configured to control the reception of the second pulse signal EM(n−1) output by the previous-stage second output unit 20 according to a two-previous-stage first pulse signal Pscan(n−2).

A control terminal of the second sub-cascading unit 242 may be connected to the output terminal of the previous-stage first output unit 10. An input terminal of the second sub-cascading unit 242 may be connected to the output terminal of the previous-stage second output unit 20. The second sub-cascading unit 242 may be configured to control the reception of the second pulse signal EM(n−1) output by the previous-stage second output unit 20 according to the previous-stage first pulse signal Pscan(n−2).

A control terminal of the cascading control unit 243 may be connected to an output terminal of the first sub-cascading unit 241 and an output terminal of the second sub-cascading unit 242. The cascading control unit 243 may be configured to control the transmission of the control signal to the control terminal of the high potential control unit 213 according to the previous-stage second pulse signal EM(n−1).

In the above embodiment, the low potential holding unit 214 may include the low potential signal line VGL and a second resistor R2. The low potential signal line VGL may be connected to the control terminal of the first potential control unit 211 and the control terminal of the second potential control unit 212 through the second resistor R2. In other embodiments, the low potential holding unit 214 may also be controlled by a transistor, which is not limited herein.

In some embodiments, the second control unit 21 may further include a reset signal line CLR. The reset signal line CLR may be connected to the third memory unit C3. The reset signal line CLR may be configured to transmit a reset signal to the third memory unit C3, such that the reset signal may be transmitted to the fourth memory unit C4 through the second memory control unit 216. In this way, the potential stored in the third memory unit C3 and the potential stored in the fourth memory unit C4 may be reset.

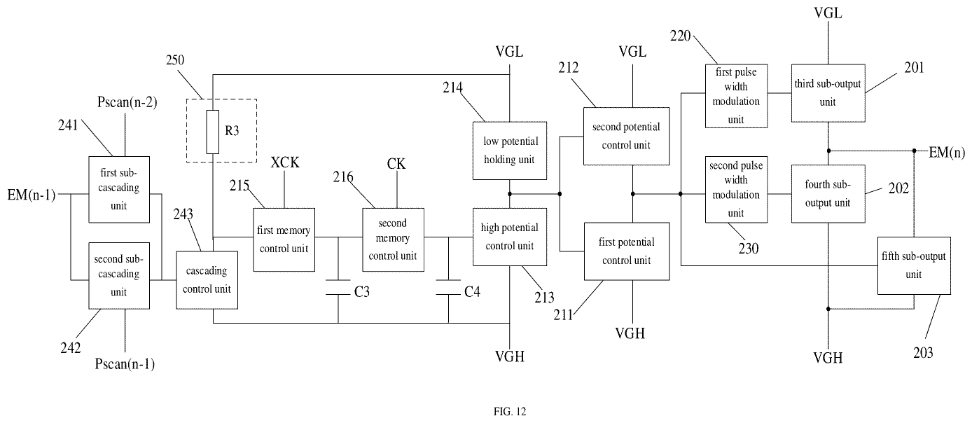

In some embodiments, the second control unit 21 may further include a reset unit 250. In some embodiments, as shown in FIG. 12, FIG. 12 is a partial schematic structural diagram of the gate driving unit according to some embodiments of the present disclosure. The reset unit 250 may include the low potential signal line VGL and a third resistor R3. The reset unit 250 may be connected to the input terminal of the first memory control unit 215. The reset unit 250 may be configured to transmit a low potential reset signal to the third memory unit C3 and the fourth memory unit C4. In some embodiments, the reset unit 250 may be connected to the input terminal of the first memory control unit 215 and an output terminal of the cascading control unit 243.

In some embodiments, when the first memory control unit 215 is turned on, the high potential stored in the third memory unit C3 may be discharged through the first memory control unit 215 and the reset unit 250. When the second memory control unit 216 is turned on, the high potential stored in the fourth memory unit C4 is discharged and reset.

It should be noted that the reset unit 250 may be a low potential reset unit in each of the plurality of gate driving units. The reset signal line CLR may be connected to all of the plurality of gate driving units. The reset signal on the reset signal line CLR may be arranged in a light-emitting period stage of other gate driving units, which may generally be placed at a blanking moment. In order to reduce a timing conflict and insufficient driving force caused by placing the reset signal in the blanking stage, the reset unit 250 may be added in each of the plurality of gate driving units.

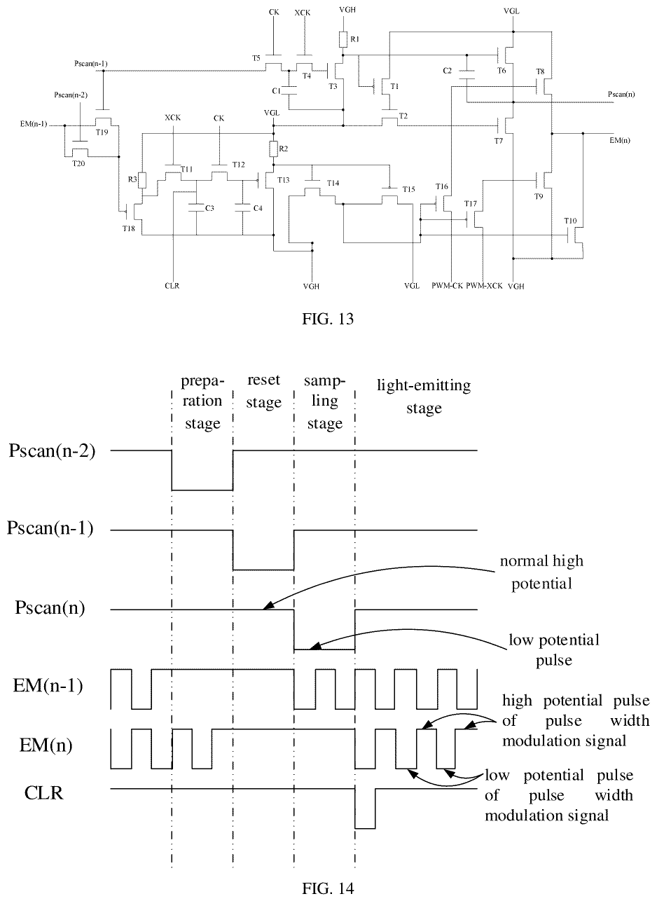

In some embodiments, as shown in FIG. 13, FIG. 13 is a schematic circuit structure diagram of the gate driving unit according to some embodiments of the present disclosure.

The first sub-control unit 111 may include the first transistor T1 and the second transistor T2. The high potential holding unit 113 may include a first resistor R1. The low potential control unit 112 may include a third transistor T3. The delay control unit 115 may include a fourth transistor T4. The first cascading unit 114 may include a fifth transistor T5. The first sub-output unit 101 may include a sixth transistor T6. The second sub-output unit 102 may include a seventh transistor T7.

The third sub-output unit 201 may include an eighth transistor T8. The fourth sub-output unit 202 may include a ninth transistor T9. The fifth sub-output unit 203 may include a tenth transistor T10. The first memory control unit 215 may include an eleventh transistor T11. The second memory control unit 216 may include a twelfth transistor T12. The low potential holding unit 214 may include a second resistor R2. The high potential control unit 213 may include a thirteenth transistor T13. The first potential control unit 211 may include a fourteenth transistor T14. The second potential control unit 212 may include a fifteenth transistor T15. The first pulse width modulation unit 220 may include a sixteenth transistor T16. The second pulse width modulation unit 230 may include a seventeenth transistor T17. The cascading control unit 243 may include an eighteenth transistor T18. The first sub-cascading unit 241 may include a nineteenth transistor T19. The second sub-cascading unit 242 may include a twentieth transistor T20.

In some embodiments, the first transistor T1, the thirteenth transistor T13, the fifteenth transistor T15, the sixteenth transistor T16, the seventeenth transistor T17, and the eighteenth transistor T18 may be the N-type transistors. Other transistors may be the P-type transistors. In other embodiments, a p-channel metal-oxide-semiconductor (PMOS) and a n-channel metal-oxide-semiconductor (NMOS) may also be reversed, which is not limited herein.

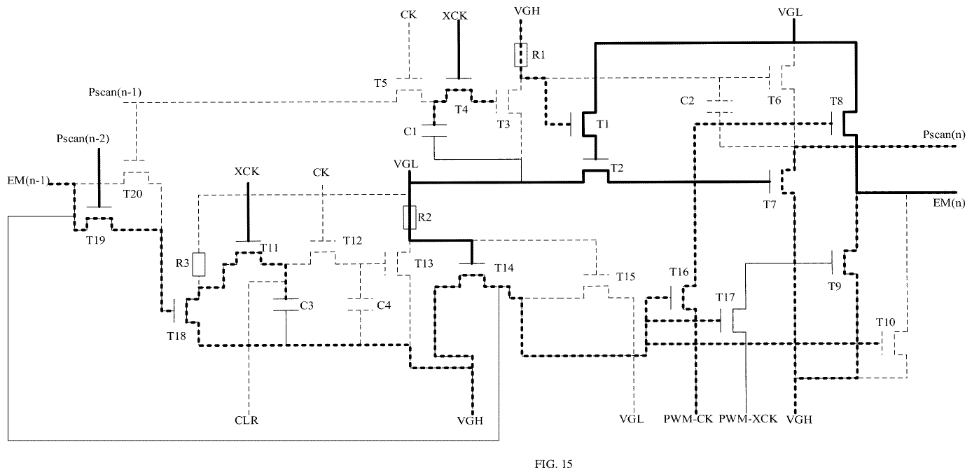

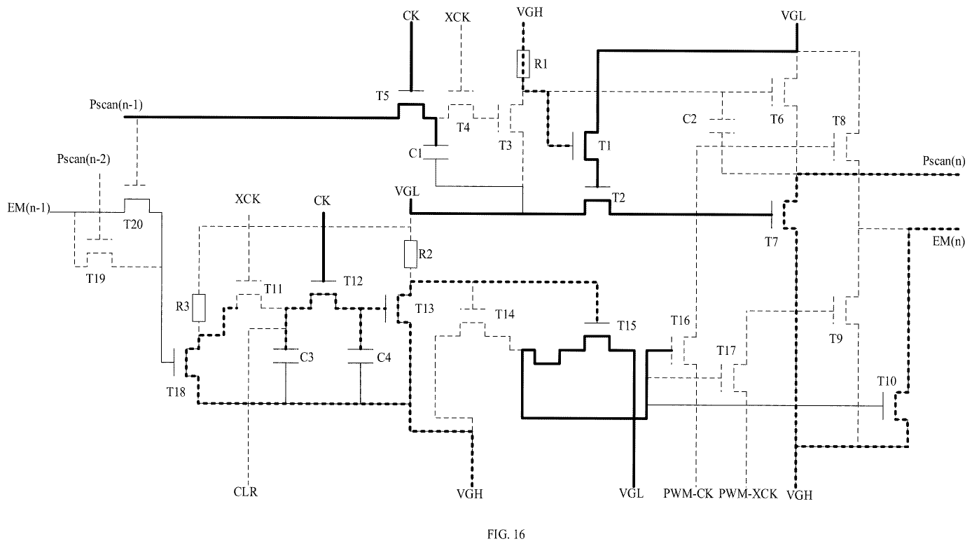

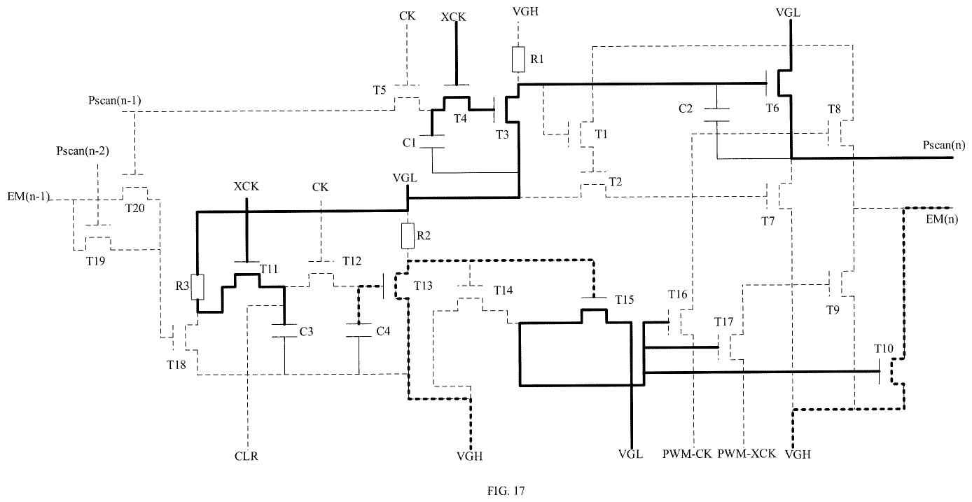

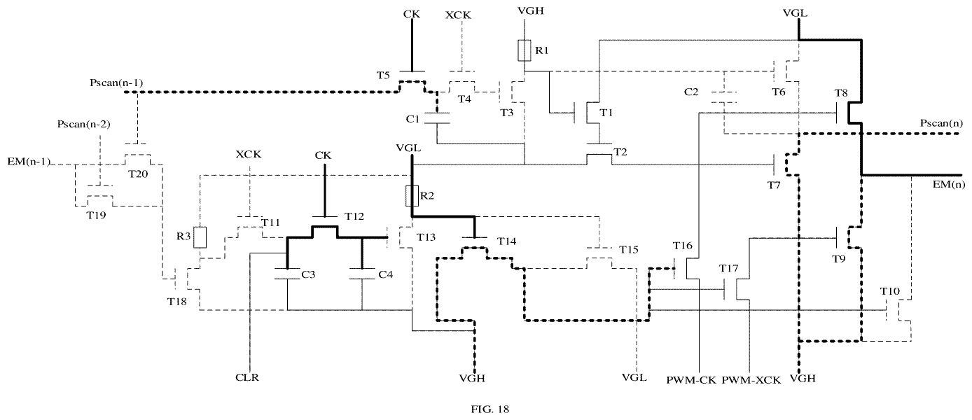

Some embodiments of the present disclosure may further provide a driving timing diagram of the gate driving unit. As shown in FIG. 14, FIG. 14 is a driving timing diagram of the gate driving unit according to some embodiments of the present disclosure. As shown in FIG. 14, a driving stage may include a preparation stage, a reset stage, a sampling stage, and the light-emitting stage. In some embodiments, as shown in FIGS. 15 to 18, FIG. 15 is a circuit diagram of a first driving stage of the gate driving unit according to some embodiments of the present disclosure. FIG. 16 is a circuit diagram of a second driving stage of the gate driving unit according to some embodiments of the present disclosure. FIG. 17 is a circuit diagram of a third driving stage of the gate driving unit according to some embodiments of the present disclosure. FIG. 18 is a circuit diagram of a fourth driving stage of the gate driving unit according to some embodiments of the present disclosure.

In the preparation stage, the first control signal line XCK may be in the low-level state, and the second control signal line CK may be in the high-level state. At this time, the fourth transistor T4 may be turned on, and the fifth transistor T5 may be turned off. The high potential stored in the first memory unit C1 during a previous cycle may pass through a gate of the fourth transistor T4, such that the third transistor T3 may be turned off, a gate of the first transistor T1 and a gate of the sixth transistor T6 may be pulled up, the first transistor T1 may be turned on, and the sixth transistor T6 may be turned off. A low potential signal of the low potential signal line VGL may be transmitted to a gate of the second transistor T2 through the first transistor T1, such that it may be possible to control the second transistor T2 to be turned on. In this way, it may be possible to enable the low potential signal of the low potential signal line VGL to be transmitted to a gate of the seventh transistor T7 through the second transistor T2, such that the seventh transistor T7 may be controlled to be turned on. At this time, the high potential signal line VGH may output the high potential pulse of the first pulse signal Pscan(n) through the seventh transistor T7.

At this time, the two-previous-stage first pulse signal Pscan(n−2) may be the low potential pulse, and the previous-stage first pulse signal Pscan(n−2) may be the high potential pulse. The nineteenth transistor T19 may be turned on, and the twentieth transistor T20 may be turned off. A high potential pulse of the previous-stage second pulse signal EM(n−1) may be applied to a gate of the eighteenth transistor T18 through the nineteenth transistor T19, such that it may be possible to control the eighteenth transistor T18 to be turned on. At this time, a high potential of the first control signal line XCK may control the eleventh transistor T11 to be turned on. A high potential signal of the high potential signal line VGH may be transmitted to an upper plate of the third memory unit C3 through the eighteenth transistor T18 and the eleventh transistor T11, thereby storing the high potential pulse signal. At this time, the low potential signal may be stored in the fourth memory unit C4 during the previous cycle, such that it may be possible to control the thirteenth transistor T13 to be turned off. At this time, the low potential signal of the low potential signal line VGL may be transmitted to a gate of the fourteenth transistor T14 and a gate of the fifteenth transistor T15 through the second resistor R2, the fourteenth transistor T14 may be turned on, and the fifteenth transistor T15 may be turned off. The high potential signal of the high potential signal line VGH may be transmitted to a gate of the sixteenth transistor T16, a gate of the seventeenth transistor T17, and a gate of the tenth transistor T10 through the fourteenth transistor T14, such that it may be possible to control the sixteenth transistor T16 and the seventeenth transistor T17 to be turned on, and control the tenth transistor T10 to be turned off. The first pulse width modulation signal line PWM-CK may transmit a first pulse width modulation signal to a gate of the eighth transistor T8 through the sixteenth transistor T16. The second pulse modulation signal line PWM-XCK may transmit a second pulse width modulation signal to the gate of the ninth transistor T9 through the seventeenth transistor T17. The first pulse width modulation signal and the second pulse width modulation signal may be configured to control the eighth transistor T8 and the ninth transistor T9 to be alternately turned on, such that it may be possible to output high/low potential pulses of the second pulse signal EM(n).

In the reset stage, the first control signal line XCK may be in the high-level state, and the second control signal line CK may be in a low-level state. At this time, the fourth transistor T4 may be turned off, and the fifth transistor T5 may be turned on. The previous-stage first pulse signal Pscan(n−1) may be the low potential pulse, and the low potential pulse may be transmitted through the fifth transistor T5 to be stored in the first memory unit C1. The third transistor T3 may remain turned off, and the high potential signal line VGH may pull up the gate of the first transistor T1 and the gate of the sixth transistor T6 through the first resistor R1, such that the first transistor T1 may be turned on and the sixth transistor T6 may be turned off. The low potential signal of low potential signal line VGL may be transmitted to the gate of the second transistor T2 through the first transistor T1, such that it may be possible to control the second transistor T2 to be turned on. In this way, it may be possible to enable the low potential signal of the low potential signal line VGL to be transmitted to the gate of the seventh transistor T7 through the second transistor T2, such that it may be possible to control the seventh transistor T7 to be turned on. At this time, the high potential signal line VGH may output the high potential pulse of the first pulse signal Pscan(n) through the seventh transistor T7.

At this time, the two-previous-stage first pulse signal Pscan(n−2) may be the high potential pulse. The previous-stage first pulse signal Pscan(n−2) may be a low potential pulse. The nineteenth transistor T19 may be turned off, and the twentieth transistor T20 may be turned on. The high potential pulse of the previous-stage second pulse signal EM(n−1) may be applied to the gate of the eighteenth transistor T18 through the twentieth transistor T20, such that it may be possible to control the eighteenth transistor T18 to be turned on. At this time, a low potential signal of the second control signal line CK may control the twelfth transistor T12 to be turned on. The high potential pulse stored in the third memory unit C3 may be transmitted to the fourth memory unit C4 and the control terminal of the thirteenth transistor T13 through the twelfth transistor T12, such that it may be possible to control the thirteenth transistor 13 to be turned on. The high potential signal of the high potential signal line VGH may be transmitted to the gate of the fourteenth transistor T14 and the gate of the fifteenth transistor T15 through the thirteenth transistor T13, such that it may be possible to control the fourteenth transistor T14 to be turned off and control the fifteenth transistor T15 to be turned on. The low potential signal of the low potential signal line VGL may be transmitted to the gate of the sixteenth transistor T16, the gate of the seventeenth transistor T17, and the gate of the tenth transistor T10 through the fifteenth transistor T15, such that it may be possible to control the sixteenth transistor T16 and the seventeenth transistor T17 to be turned off, and control the tenth transistor T10 to be turned on. The high potential signal line VGH may output a high potential pulse of the second pulse signal EM(n) through the tenth transistor T10.

In the sampling stage, the first control signal line XCK may be in the low-level state, and the second control signal line CK may be in the high-level state. At this time, the fourth transistor T4 may be turned on, and the fifth transistor T5 may be turned off. The low potential signal stored in the first memory unit C1 during the previous cycle may be transmitted to a gate of the third transistor T3 through the fourth transistor T4, such that the third transistor T3 may be turned on. The low potential signal of the low potential signal line VGL may be transmitted to the gate of the first transistor T1 and the gate of the sixth transistor T6 through the third transistor T3, such that the first transistor T1 may be turned off and the sixth transistor T6 may be turned on. At this time, the low potential signal line VGL may output the low potential pulse of the first pulse signal Pscan(n) through the sixth transistor T6.

At this time, the two-previous-stage first pulse signal Pscan(n−2) may be the high potential pulse, and the previous-stage first pulse signal Pscan(n−2) may be the high potential pulse. The nineteenth transistor T19 may be turned off, and the twentieth transistor T20 may be turned off. The eighteenth transistor T18 may be turned off. At this time, a high potential signal of the first control signal line XCK may control the eleventh transistor T11 to be turned on. The low potential signal of the low potential signal line VGL may be transmitted through the third resistor R3 and the eleventh transistor T11 to be stored in the upper plate of the third memory unit C3, thereby storing the low potential pulse signal. At this time, the fourth memory unit C4 may store the high potential signal during the previous cycle, such that it may be possible to control the thirteenth transistor T13 to be turned on. At this time, the high potential signal of the high potential signal line VGH may be transmitted to the gate of the fourteenth transistor T14 and the gate of the fifteenth transistor T15 through the thirteenth transistor T13, such that it may be possible to control the fourteenth transistor T14 to be turned off and control the fifteenth transistor T15 to be turned on. The low potential signal of the low potential signal line VGL may be transmitted to the gate of the sixteenth transistor T16, the gate of the seventeenth transistor T17, and the gate of the tenth transistor T10 through the fifteenth transistor T15, such that it may be possible to control the sixteenth transistor T16 and the seventeenth transistor T17 to be turned off, and control the tenth transistor T10 to be turned on. The high potential signal line VGH may output the high potential pulse of the second pulse signal EM(n) through the tenth transistor T10.

In the light-emitting stage, the first control signal line XCK may be in the high-level state, and the second control signal line CK may be in the low-level state. At this time, the fourth transistor T4 may be turned off, and the fifth transistor T5 may be turned on. The previous-stage first pulse signal Pscan(n−1) may be the low potential pulse, and the low potential pulse may be transmitted through the fifth transistor T5 to be stored in the first memory unit C1. The third transistor T3 may remain turned off. The high potential signal line VGH may pull up the gate of the first transistor T1 and the gate of the sixth transistor T6 through the first resistor R1, such that the first transistor T1 may be turned on and the sixth transistor T6 may be turned off. The low potential signal of the low potential signal line VGL may be transmitted to the gate of the second transistor T2 through the first transistor T1, such that it may be possible to control the second transistor T2 to be turned on. In this way, it may be possible to enable the low potential signal of the low potential signal line VGL to be transmitted to the gate of the seventh transistor T7 through the second transistor T2, such that it may be possible to control the seventh transistor T7 to be turned on. At this time, the high potential signal line VGH may output the high potential pulse of the first pulse signal Pscan(n) through the seventh transistor T7.

At this time, the two-previous-stage first pulse signal Pscan(n−2) may be the high potential pulse, and the previous-stage first pulse signal Pscan(n−2) may be the high potential pulse. The nineteenth transistor T19 may be turned off, and the twentieth transistor T20 may be turned off. The eighteenth transistor T18 may be turned off. At this time, the low potential signal of the second control signal line CK may control the twelfth transistor T12 to be turned on. The low potential signal stored in the third memory unit C3 may be transmitted to the fourth memory unit C4 and the gate of the thirteenth transistor T13 through the twelfth transistor T12, such that it may be possible to control the thirteenth transistor 13 to be turned off. At this time, the low potential signal of the low potential signal line VGL may be transmitted to the gate of the fourteenth transistor T14 and the gate of the fifteenth transistor T15 through the second resistor R2, the fourteenth transistor T14 may be turned on, and the fifteenth transistor T15 may be turned off. The high potential signal of the high potential signal line VGH may be transmitted to the gate of the sixteenth transistor T16, the gate of the seventeenth transistor T17, and the gate of the tenth transistor T10 through the fourteenth transistor T14, such that it may be possible to control the sixteenth transistor T16 and the seventeenth transistor T17 to be turned on, and control the tenth transistor T10 to be turned off. The first pulse width modulation signal line PWM-CK may transmit the first pulse width modulation signal to the gate of the eighth transistor T8 through the sixteenth transistor T16. The second pulse modulation signal line PWM-XCK may transmit the second pulse width modulation signal to the gate of the ninth transistor T9 through the seventeenth transistor T17. The first pulse width modulation signal and the second pulse width modulation signal may be configured to control the eighth transistor T8 and the ninth transistor T9 to be alternately turned on, such that it may be possible to output the high/low potential pulses of the second pulse signal EM(n).

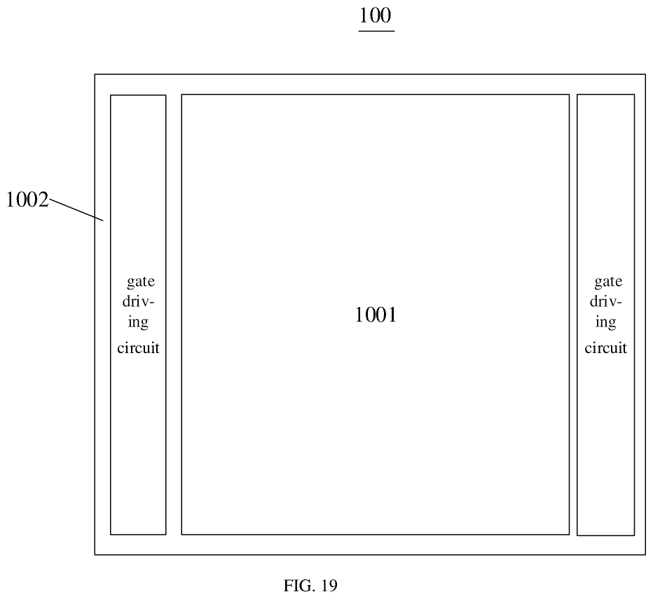

Some embodiments of the present disclosure may further provide a display panel. In some embodiments, as shown in FIG. 19, FIG. 19 is a schematic structural diagram of a display panel according to some embodiments of the present disclosure. As shown in FIG. 19, a display panel 100 may include a display region 1001 and a non-display region 1002. The gate driving circuit according to any one of the above-mentioned embodiments may be arranged in the non-display region 1002 disposed at a side or opposite sides of the display panel 100. The gate driving circuit may include the plurality of gate driving units connected in cascades. The gate driving circuit may be configured to sequentially transmit the first pulse signal Pscan(n) and the second pulse signal EM(n) to each row of pixel units in the display region 1001.

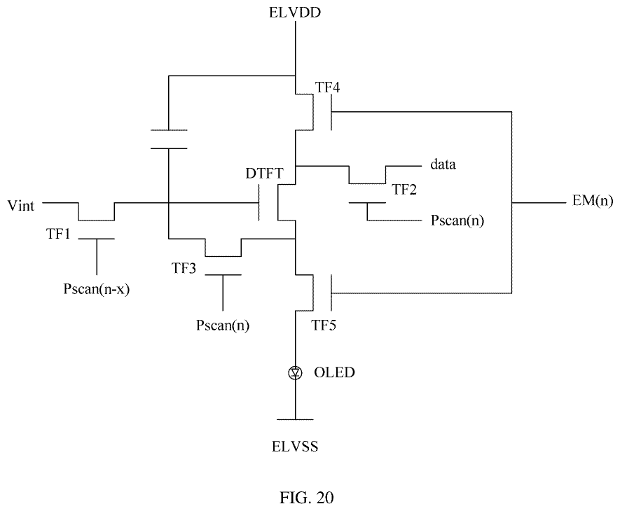

Each pixel unit in the display region 1001 may include a pixel driving circuit. In some embodiments, as shown in FIG. 20, FIG. 20 is schematic structural diagram of a pixel driving circuit according to some embodiments of the present disclosure. The gate driving circuit may be configured to sequentially transmit the first pulse signal Pscan(n) and the second pulse signal EM(n) to the pixel driving circuits in each row of pixel units in the display region 1001. In the sampling stage, the first pulse signal Pscan(n) may be configured to control a data writing transistor TF2 to write a data signal to a gate of the driving transistor DTFT of the pixel driving circuit. In the light-emitting stage, the second pulse signal EM(n) may be configured to transmit a switch signal to a switch transistor TF4 and a switch transistor TF5, such that it may be possible to enable the driving transistor DTFT to drive the light-emitting device OLED to emit light.

By designing the above-mentioned gate driving circuit in the embodiments of the present disclosure, while minimizing the use of input signals, it may be possible to enable a gate driver on array (GOA) circuit to transmit a scan signal and a switch signal to the pixel unit, such that circuit costs may be saved and a frame width may be reduced. In addition, it may be possible to enable a corresponding one of the gate driving circuits to sequentially output a scan signal and a switch signal to each row of pixel units, such that it may be possible to control a light-emitting device in the display panel to emit light.

The above are only the embodiments of the present disclosure, and are not intended to limit the patent scope of the present disclosure. Any equivalent structure or equivalent process transformation made by using the contents of the specification and drawings of the present disclosure, or directly or indirectly applied in other related technical fields, shall be similarly included in the patent protection scope of the present disclosure.

1. A gate driving circuit, comprising a plurality of gate driving units connected in cascades, wherein each of the gate driving units comprises:
a first output unit, configured to output a first pulse signal, wherein the first pulse signal is a low potential pulse with a normal high potential;
a second output unit, configured to output a second pulse signal, wherein the second pulse signal is a pulse width modulation signal accompanied by a high potential pulse;
a first control unit, connected to a control terminal of the first output unit and configured to control the first output unit to output the first pulse signal; and
a second control unit, connected to a control terminal of the second output unit and configured to control the second output unit to output the second pulse signal.

2. The gate driving circuit according to claim 1, wherein the first output unit comprises a first sub-output unit and a second sub-output unit;
the first sub-output unit is connected to a high potential signal line and configured to output a high potential pulse according to a control signal output by the first control unit;
the second sub-output unit is connected to a low potential signal line and configured to output a low potential pulse according to the control signal output by the first control unit.

3. The gate driving circuit according to claim 2, wherein the first control unit comprises:
a first sub-control unit, connected to a control terminal of the first sub-output unit, wherein the first sub-control unit is configured to output a turn-on signal to the first sub-output unit, and the first sub-output unit is controlled to output the high potential pulse;
a low potential control unit, connected to a control terminal of the first sub-control unit and a control terminal of the second sub-output unit, wherein the low potential control unit is configured to transmit a low potential control signal to the control terminal of the first sub-control unit and the control terminal of the second sub-output unit, the second sub-output unit is controlled, and the first sub-output unit is controlled through the first sub-control unit; and
a high potential holding unit, connected to the control terminal of the first sub-control unit and the control terminal of the second sub-output unit, wherein the high potential holding unit is configured to hold the control terminal of the first sub-control unit and the control terminal the second sub-output unit in a high-level state, so as to control outputting of the first sub-output unit and outputting of the second sub-output unit.

4. The gate driving circuit according to claim 3, wherein the first control unit further comprises:
a first cascading unit, connected to a previous-stage first output unit and configured to receive a first pulse signal transmitted by the previous-stage first output unit;
a first memory unit, connected to the first cascading unit and configured to store a potential signal of the previous-stage first pulse signal; wherein the potential signal comprises a high potential signal and a low potential signal; and
a delay control unit, connected to the first memory unit and a control terminal of the low potential control unit, wherein the delay control unit is configured to transmit the potential signal stored in the first memory unit to the control terminal of the low potential control unit, and the low potential control unit is controlled to be turned on or turned off.

5. The gate driving circuit according to claim 4, wherein a control terminal of the first cascading unit and a control terminal of the delay control unit are connected to a group of control signal lines with opposite pulse phases.

6. The gate driving circuit according to claim 3, wherein the first sub-control unit comprises the low potential signal line and a first transistor;
wherein an input terminal of the first transistor is connected to the low potential signal line, an output terminal of the first transistor is connected to the control terminal of the first sub-output unit, a control terminal of the first transistor is connected to the high potential holding unit and the low potential control unit, and the first transistor is configured to control the low potential signal line to output the turn-on signal to the first sub-output unit according to the high potential holding unit and a control signal output by the low potential control unit;
the first transistor is an N-type transistor.

7. The gate driving circuit according to claim 3, wherein the high potential holding unit comprises a high potential signal line and a first resistor, and the high potential signal line is connected to the control terminal of the first sub-control unit and the control terminal of the first sub-output unit through the first resistor.

8. The gate driving circuit according to claim 1, wherein the second output unit comprises:
a third sub-output unit, connected to a low potential signal line and configured to output a low potential pulse according to a first pulse width modulation signal;
a fourth sub-output unit, connected to a high potential signal line and configured to output a high potential pulse of a pulse width modulation signal according to a second pulse width modulation signal;
a fifth sub-output unit, connected to the high potential signal line and configured to output a high potential according to a control signal output by the second control unit;
a first pulse width modulation unit, connected to a control terminal of the third sub-output unit and configured to output the first pulse width modulation signal to the control terminal of the third sub-output unit; and
a second pulse width modulation unit, connected to a control terminal of the fourth sub-output unit and configured to output the second pulse width modulation signal to the control terminal of the fourth sub-output unit;
wherein the first pulse width modulation signal and the second pulse width modulation signal are a group of level signals with opposite pulse phases.

9. The gate driving circuit according to claim 8, wherein the second control unit comprises:
a first potential control unit, an input terminal of the first potential control unit being connected to a high potential signal line, and an output terminal of the first potential control unit being connected to a control terminal of the first pulse width modulation unit, a control terminal of the second pulse width modulation unit and a control terminal of the fifth sub-output unit, wherein the first potential control unit is configured to transmit a high potential control signal to the control terminal of the first pulse width modulation unit, the control terminal of the second pulse width modulation unit and the control terminal of the fifth sub-output unit;
a second potential control unit, an input terminal of the second potential control unit being connected to a low potential signal line, an output terminal of the second potential control unit being connected to the control terminal of the first pulse width modulation unit, the control terminal of the second pulse width modulation unit and the control terminal of the fifth sub-output unit, wherein the second potential control unit is configured to transmit a low potential control signal to the control terminal of the first pulse width modulation unit, the control terminal of the second pulse width modulation unit and the control terminal of the fifth sub-output unit.

10. The gate driving circuit according to claim 9, wherein the second control unit further comprises:
a high potential control unit, connected to a control terminal of the first potential control unit and a control terminal of the second potential control unit, wherein the high potential control unit is configured to control the first potential control unit to be turned on or turned off and control the second potential control unit to be turned on or turned off; and
a low potential holding unit, connected to the control terminal of the first potential control unit, the control terminal of the second potential control unit and an output terminal of the high potential control unit, wherein the low potential holding unit is configured to hold the control terminal of the first potential control unit and the control terminal of the second potential control unit in a low-level state in a case where the high potential control unit does not output;
wherein the first potential control unit and the second potential control unit comprise a group of transistors with opposite driving characteristics.

11. The gate driving circuit according to claim 10, wherein the second control unit further comprises:
a second cascading unit, connected to a previous-stage second output unit and configured to receive a second pulse signal output by the previous-stage second output unit;
a first memory control unit, connected to the second cascading unit and configured to transmit a control signal according to the second cascading unit;
a third memory unit, connected to the first memory control unit and configured to store the control signal transmitted by the first memory control unit;
a second memory control unit, connected to the third memory unit and configured to control the third memory unit to transmit the control signal to a control terminal of the high potential control unit; and
a fourth memory unit, connected to the second memory control unit and configured to store the control signal transmitted by the second memory control unit;
wherein a control terminal of the first memory control unit is connected to one of two control signal lines with opposite pulse phases, and a control terminal of the second memory control unit is connected to the other one of the two control signal lines with opposite pulse phases.

12. The gate driving circuit according to claim 11, wherein the second control unit further comprises a reset signal line, connected to the third memory unit;
the reset signal line is configured to transmit a reset signal to the third memory unit, and the reset signal is transmitted to the fourth memory unit.

13. The gate driving circuit according to claim 10, wherein the low potential holding unit comprises a low potential signal line and a second resistor, and the low potential signal line is connected to the control terminal of the first potential control unit and the control terminal of the second potential control unit through the second resistor.

14. The gate driving circuit according to claim 11, wherein the second control unit further comprises a reset unit, comprising a low potential signal line and a third resistor;
the reset unit is connected to an input terminal of the first memory control unit and configured to transmit a low potential reset signal to the third memory unit and the fourth memory unit.

15. The gate driving circuit according to claim 1, wherein the second pulse signal comprises a normal high potential pulse, and a high potential pulse and a low potential pulse of a pulse width modulation signal.

16. The gate driving circuit according to claim 15, wherein the second output unit comprises:
a third sub-output unit, connected to a low potential signal line and configured to output the low potential pulse of the pulse width modulation signal;
a fourth sub-output unit, connected to a high potential signal line and configured to output the high potential pulse of the pulse width modulation signal;
a fifth sub-output unit, connected to the high potential signal line and configured to output the normal high potential pulse; and
a pulse width modulation unit, connected to a control terminal of the third sub-output unit and a control terminal of the fourth sub-output unit;
wherein the pulse width modulation unit is configured to output a pulse width modulation control signal, and the third sub-output unit and the fourth sub-output unit are alternately turned on in a light-emitting stage to generate the pulse width modulation signal.

17. The gate driving circuit according to claim 16, wherein the pulse width modulation unit comprises:
a first pulse width modulation unit, connected to a control terminal of the third sub-output unit and configured to output the first pulse width modulation signal to the control terminal of the third sub-output unit; and
a second pulse width modulation unit, connected to a control terminal of the fourth sub-output unit and configured to output the second pulse width modulation signal to the control terminal of the fourth sub-output unit;
wherein the first pulse width modulation signal and the second pulse width modulation signal are a group of level signals with opposite pulse phases.

18. The gate driving circuit according to claim 3, wherein the first sub-control unit comprises the low potential signal line, a first transistor turned on in the high-level state, and a second transistor turned on in the low-level state;
wherein the second transistor is disposed between control terminals of the first transistor;
a control terminal of the second transistor is connected to an output unit of the first transistor and is turned on in response to receiving the low potential signal, an input terminal of the second transistor is connected to the low potential signal line, and an output terminal of the second transistor is connected to the control terminal of the first sub-output unit.

19. The gate driving circuit according to claim 13, wherein the second cascading unit comprises:
a first sub-cascading unit, a control terminal of the first sub-cascading unit being connected to an output terminal of a two-previous-stage first output unit 10, and an input terminal of the first sub-cascading unit being connected to the output terminal of a previous-stage second output unit;
a second sub-cascading unit, a control terminal of the second sub-cascading unit being connected to an output terminal of a previous-stage first output unit, and an input terminal of the second sub-cascading unit being connected to the output terminal of the previous-stage second output unit; and
a cascading control unit, a control terminal of the cascading control unit being connected to an output terminal of the first sub-cascading unit and an output terminal of the second sub-cascading unit.

20. A display panel, comprising a gate driving circuit;
wherein the display panel further comprises a display region and a non-display region, and the gate driving circuit is arranged in the non-display region;
wherein the gate driving circuit comprises a plurality of gate driving units connected in cascades, and each of the gate driving units comprises:
a first output unit, configured to output a first pulse signal, wherein the first pulse signal is a low potential pulse with a normal high potential;
a second output unit, configured to output a second pulse signal, wherein the second pulse signal is a pulse width modulation signal accompanied by a high potential pulse;
a first control unit, connected to a control terminal of the first output unit and configured to control the first output unit to output the first pulse signal; and
a second control unit, connected to a control terminal of the second output unit and configured to control the second output unit to output the second pulse signal.
